(19) United States
(12) Patent Application Publication
(10) Pub. No.: US 2026/0155130 A1
(43) Pub. Date: Jun. 4, 2026

(54) STANDARDIZED WEB NAVIGATION SHORTCUTS FOR VISUALLY CHALLENGED USERS

(71) Applicant: ServiceNow, Inc., Santa Clara, CA (US)

(72) Inventor: Anil Kumar Akula, Hyderabad (IN)

(21) Appl. No.: 18/968,049

(22) Filed: Dec. 4, 2024

(51) Int. Cl. G10L 13/02; G06F 3/16; G09B 21/00

(52) U.S. Cl. CPC G10L 13/02; G06F 3/167; G09B 21/006

(57) ABSTRACT

A method includes obtaining an indication of a user input and determining a targeted element class associated with an application having a plurality of application elements based on the indication of the user input. The method also includes identifying a subset of the plurality of application elements based on the targeted element class and synthesizing a plurality of speech segments respectively associated with the subset of the plurality of application elements.

### TECHNICAL FIELD

This disclosure relates to web navigation shortcuts.

### BACKGROUND

A screen reader is a tool for visually impaired individuals that enables them to access and interact with digital content. These software applications convert text and objects displayed on a screen into synthesized speech. One technical challenge for screen readers is providing accurate and efficient interpretation of complex web layouts and dynamic content, which can result in incomplete or incorrect information being conveyed to the user. Moreover, screen readers operate across various different operating systems and applications. As digital environments become increasingly diverse, screen readers may be faced with a compatibility issue of interacting with a wide range of software and hardware configurations. This compatibility issue may result in inconsistent performance, where certain features or functionalities may not be fully supported across different platforms. The compatibility issue is further exacerbated by the rapid evolution of web standards and application interfaces that requires continuous updates and improvements to screen readers.

### SUMMARY

One implementation of the disclosure provides a computer-implemented method of using a screen reader to provide standardized web navigation shortcuts. The method includes obtaining an indication of a user input and determining a targeted element class associated with an application having a plurality of application elements based on the indication of the user input. The method also includes identifying a subset of the plurality of application elements based on the targeted element class and synthesizing a plurality of speech segments respectively associated with the subset of the plurality of application elements.

Implementations of the disclosure may include one or more of the following optional features. In some implementations, each of the plurality of synthesized speech segments is indicative of a corresponding one of the subset of the plurality of application elements. In these implementations, each of the plurality of synthesized speech segments may describe a respective action characterized by the corresponding one of the subset of the plurality of application elements. Identifying the subset of the plurality of application elements may include determining that each of the subset of the plurality of application elements satisfies a relevance criterion with respect to the targeted element class. In some examples, the method further includes playing the plurality of speech segments via an output audio device. The method may further include assigning the targeted element class to application elements of a plurality of different applications.

In some implementations, the plurality of application elements of the application includes a sequential order and a screen reader configured to generate synthesized speech that describes a respective action the respective application element is configured to perform for each respective application element and output the synthesized speech based on the sequential order. Here, the method may further include modifying the sequential order of the plurality of application elements to move each identified application element earlier in the sequential order than other application elements based on identifying the subset of the plurality of application elements. In these implementations, the sequential order may include a left-to-right and a top-down order of the plurality of application elements. The indication of the user input may include at least one of a keyboard shortcut, a touch input, or a voice command. The method may further include receiving another indication of another user input selecting a respective action described by one of the plurality of speech segments after synthesizing the plurality of speech segments and performing the respective action based on receiving the other indication of the other user input.

In some implementations, each respective application element of the plurality of application elements is associated with a respective access control level. In these implementations, the respective access control level may be required to perform a respective action associated with the respective application element. Here, the method may further include determining user rights of a user associated with the user input. For each respective application element in the subset of the plurality of application elements, the method may include determining that the user rights satisfy the respective access control level. In some examples, the application includes a web-based application or a mobile application. Determining the targeted element class includes determining, from a plurality of different targeted element classes, that the targeted element class is mapped to the indication of the user input. In some implementations, the method further includes executing the application where each application element of the plurality of application elements is configured to perform a respective action associated with the application and assigned to a respective targeted element class of a plurality of targeted element classes.

Another implementation of the disclosure provides a system that includes data processing hardware and memory hardware storing instructions that when executed on the data processing hardware causes the data processing hardware to perform operations. The operations include obtaining an indication of a user input and determining a targeted element class associated with an application having a plurality of application elements based on the indication of the user input. The operations also include identifying a subset of the plurality of application elements based on the targeted element class and synthesizing a plurality of speech segments respectively associated with the subset of the plurality of application elements.

Another implementation of the disclosure provides a computer-readable medium having instructions that, when executed by data processing hardware, causes the data processing hardware to perform operations. The operations include obtaining an indication of a user input and determining a targeted element class associated with an application having a plurality of application elements based on the indication of the user input. The operations also include identifying a subset of the plurality of application elements based on the targeted element class and synthesizing a plurality of speech segments respectively associated with the subset of the plurality of application elements.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system executing a screen reader.

FIG. 2 is a schematic view of an example selector of the screen reader.

FIG. 3 is a schematic view of the screen reader generating an output for an example user input.

FIG. 4 is a flowchart of an example arrangement of operations for a computer-implemented method of using a screen reader to provide standardized web navigation shortcuts.

FIG. 5 is a schematic view of an example computing device that may be used to implement the systems and methods described herein.

Like reference symbols in the various drawings indicate like elements.

### DETAILED DESCRIPTION

Visually impaired users have difficulty interacting with digital content because most digital interfaces are designed with visual cues and elements that are not easily accessible without sight. Accordingly, visually impaired users will often use a screen reader which is an assistive tool that helps users with visual impairment access and interact with digital content. The screen reader converts text and other visual elements on screens of user devices into synthesized speech thereby allowing users to hear and interact with the information instead of seeing it. As such, screen readers enable visually impaired users to navigate websites, read documents, send emails, and perform various other tasks that require interaction with user devices.

However, presenting all the content on the screen of devices audibly is a process that requires a significant amount of time and computing resources for the screen reader to perform. For example, a screen reader may sequentially parse through the entire content of an application to convert text and visual elements into synthetic speech. Notably, this is a sequential or linear approach that requires users to wait for the screen reader to read through each element one by one. Moreover, a screen reader may provide a user with various navigation options, such as navigating between headings, links, or sections. However, this requires the screen reader to maintain an internal map of the content, which may consume additional time and computing resources.

To that end, implementations herein are directed towards a screen reader that provides shortcuts for visually challenged users of digital content. The screen reader obtains an indication of a user input and determines a targeted element class associated with an application having a plurality of application elements based on the indication of the user input. The screen reader also identifies a subset of the plurality of application elements based on the targeted element class and synthesizes a plurality of speech segments respectively associated with the subset of the plurality of application elements.

Accordingly, the user input indications, such as touch inputs, keyboard shortcuts, and/or voice commands, enable users to direct the screen reader to a target element class mapped to the user input indication. Thus, instead of requiring the screen reader to sequentially output all the content on a screen, which consumes a significant amount of time and computing resources, the user input indications direct the screen reader directly to the content associated with the target element class the user is interested in. Thus, the user input indications enable the screen reader to only output synthesized speech for the application elements associated with the target element class instead of sequentially processing all of the application elements displayed on a screen. By directly outputting the synthesized speech for the application elements associated with the target element class, the amount of computing resources consumed is reduced.

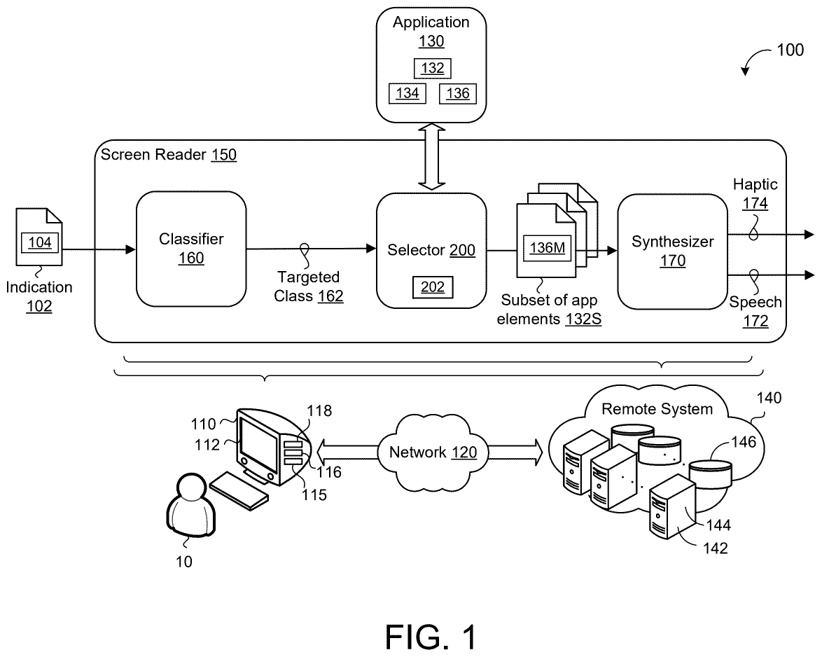

Referring to FIG. 1, in some implementations, a system 100 includes a remote system 140 in communication with one or more user device 110 each associated with a respective user 10 via a network 120, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 120. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware). The user device 110 may include an output audio device (e.g., a speaker) 115 and a screen (i.e., graphical user interface) 112.

The user device 110 and/or the remote system 140 may execute an application 130 or a plurality of applications 130 each having a plurality of application elements 132. The user 10 may control which of the one or more applications 130 currently execute on the user device 110 by interacting with the user device 110. The application 130 may be a web-based application or a mobile application. As will become apparent, each application element 132 of the plurality of application elements is configured to perform a respective action 134 associated with the application 130 when selected. The application elements 132 may include a wide range of interactive components within the application 130 including, but not limited to, text, objects, and selectable buttons. For instance, text elements may include paragraphs, headings, labels, and any other written content that may be read aloud. Objects may include images, icons, and other graphical representations that may be described to the user 10. Selectable buttons may include standard buttons for submitting forms, navigation buttons for moving between different sections of the application 130, and toggle buttons for enabling or disabling certain features.

Moreover, application elements 132 may include interactive forms, such as text input fields, checkboxes, radio buttons, and dropdown menus, all of which may be manipulated or selected within the application 130. Hyperlinks, which direct the user 10 to different web pages or sections within the application 130, may also be considered application elements 132. In some configurations, application elements 132 include dynamic elements, such as pop-up notifications, tooltips, and modal dialogs. Dynamic elements provide critical information or require user interaction.

The remote system 140 and/or the user device 110 may execute a screen reader 150. For instance, some components of the screen reader 150 may execute on the data processing hardware 116 of the user device 110 while other components of the screen reader 150 execute on the data processing hardware 144 of the remote system 140. The screen reader 150 includes a classifier 160, a selector 200, and a synthesizer 170. The classifier 160 of the screen reader 150 obtains or receives an indication 102 of a user input 104. The indication 102 of the user input 104 may include at least one of a keyboard shortcut, a touch input, or a voice command.

Keyboard shortcuts are predefined combinations of keys that, when pressed simultaneously, trigger the screen reader 150 to perform specific actions. Thus, keyboard shortcuts allow users 10 to quickly navigate through content using the screen reader 150 without having to rely on a computer mouse or other pointing device. For example, a keyboard shortcut may include pressing “Ctrl+Alt+N” simultaneously or pressing “Ctrl+Alt+P” simultaneously. Touch inputs refer to gestures made on a touch-sensitive surface of the user device 110, such as a touchscreen or a touchpad of the user device 110. Thus, users 10 may interact with the screen reader 150 by performing various gestures, such as swiping, tapping, or pinching. For instance, a touch input may include a single tap at a particular region of the touchscreen or a double tap at a particular region of the touchscreen. Swiping gestures involve moving one or more fingers across the touch-sensitive surface in a specific direction. On the other hand, pinching gestures involve placing two or more fingers on the touch-sensitive surface and either bringing them together (e.g., pinching gesture) or spreading them apart (e.g., reverse pinching gestures).

Voice commands enable users 10 to control the screen reader 150 through spoken input. As such, the screen reader 150 may include an automated speech recognition (ASR) model and/or a multimodal large language model (LLM) that processes speech input spoken by the user 10 and converts the speech input into a corresponding transcription. For example, a voice command may include the spoken input of “read headings.” In some examples, the voice commands spoken by the user 10 may correspond to hotwords or warm words such that a hotword detection model or keyword detection model may recognize the spoken voice command without performing speech recognition (e.g., natural language processing or semantic interpretation) on the audio data. Advantageously, using the hotword or keyword detection model, rather than performing speech recognition, may reduce the amount of computing resources consumed by the screen reader 150 to transcribe the spoken input. In some implementations, the screen reader 150 receives other forms of user input 104, such as mouse clicks, joystick movements, or eye-tracking technology.

In some examples, the indication 102 of the user input 104 is unique to a particular application 130. That is, the user input 104 may only correspond to the particular application 130 and not correspond to any other applications 130. In other examples, however, the indication 102 of the user input 104 may be agnostic to the particular application 130 or applications 130 currently executing on the user device 110. That is, the indication 102 of the user input 104 may be standard across all applications 130 such that the indication 102 of the user input 104 is not tailored specifically toward a particular application 130.

This standardization of the user input 104 provides several advantages. First, the standardization simplifies the development process for both the screen reader 150 and the applications 130. Developers of the screen reader 150 do not need to create custom user inputs 104 for each application 130 and application developers do not need to modify their applications 130 to accommodate different user inputs 104. Second, standardized user inputs 104 enhances the user experience by providing a consistent interaction model across different applications 130. Users 10 do not need to learn different user inputs 104 for each application 130, which can be particularly beneficial for users 10 with disabilities who rely on screen readers 150 for accessibility. Moreover, standardization of user inputs 104 improves the reliability and performance of the screen reader 150. Since the user input 104 is uniform across all applications 130, the screen reader 150 may be optimized to handle user inputs 104 more efficiently. Standardized user inputs 104 also facilitates improved interoperability between different software and hardware platforms. As the same user input 104 is recognized and processed uniformly, it allows for seamless integration with various devices and operating systems. This seamless integration can expand the reach of the screen reader 150, making it accessible to a broader audience.

The classifier 160 determines a targeted element class 162 based on the indication 102 of the user input 104. The targeted element class 162 is associated with the application 130 applications currently executing on the user device 110 whereby each application 130 has a plurality of application elements 132. The classifier 160 may determine the targeted element class 162 by determining, from a plurality of different targeted element classes 162, that the targeted element class 162 is mapped to the indication 102 of the user input 104. That is, each targeted element class 162 of the plurality of targeted element classes 162 may be mapped to one or more corresponding user inputs 104. For example, a first targeted element class 162 may be mapped to the keyboard shortcut of “Ctrl+Alt+A” while a second targeted element class may be mapped to the keyboard shortcut of “Ctrl+Alt+B.” In some configurations, each targeted element class 162 is shared or common among a plurality of different applications 130. That is, the system 100 may assign each targeted element class 162 to application elements 132 of the plurality of different applications 130.

The targeted element class 162 may indicate the class or type of application element 132. This classification enables the screen reader 150 to identify and interact with various application elements 132 that are similar within an application 130. For instance, the targeted class 162 may be assigned to readable application elements 132 or selectable button application elements 132. Simply put, the targeted element class 162 enables the screen reader 150 to group similar application elements 132 within an application such that the grouping of similar application elements 132 may be presented to the user 10.

The selector 200 receives the targeted element class 162 determined by the classifier 160 and identifies a subset of the plurality of application elements 132, 132S from the plurality of application elements 132 of the application 130 executing on the user device 110 based on the targeted element class 162. Each application element 132 of the plurality of application elements 132 may be assigned to a respective targeted element class 162 of the plurality of targeted element classes 162. One or more application elements 132 may be assigned to a respective targeted element class 162 for a respective application 130. Thus, a respective targeted element class 162 may be assigned to multiple similar application elements 132 of the application.

As such, the selector 200 may identify the subset of the plurality of application elements 132S by determining the application elements 132 from the application 130 that are assigned to the targeted element class 162. In some implementations, the selector 200 identifies the subset of the plurality of application elements 132S from the plurality of application elements 132 that are currently being displayed on the screen 112 of the user device 110. Here, application elements 132 that are not currently being displayed on the screen 112 of the user device 110, may not be identified by the selector 200. In other implementations, the selector 200 identifies the subset of the plurality of application elements 132S from all of the application elements 132 of the application 130, regardless of whether the application element 132 is currently being displayed or not.

In some implementations, the selector 200 identifies the subset of the plurality of application elements 132S by determining that each application element 132 in the subset of the plurality of application elements 132S satisfies a relevance criterion 202 with respect to the targeted element class 162. That is, some application elements 132 may not be mapped to a corresponding targeted element class 162. As such, the selector 200 may process each application element 132 to determine whether the content of the application element 132 satisfies a relevance criterion 202 with respect to the targeted element class 162. For instance, the selector 200 may use natural language processing to determine whether a textual application element 132 satisfies the relevance criterion 202 with respect to the targeted element class 162 or use image processing to determine whether an image or graphical representation application element 132 satisfies the relevance criterion 2202 with respect to the targeted element class 162. When a respective application element 132 satisfies the relevance criterion 202, the selector 200 adds the respective application element 132 to the subset of the plurality of application elements 132S. Otherwise, the selector 200 does not add the respective application element 132 to the subset of the plurality of application elements 132S.

Thereafter, the synthesizer 170 receives the subset of application elements 132 from the selector 200 and synthesizes a plurality of speech segments 172 respectively associated with the subset of the plurality of application elements 132S. Here, each of the plurality of synthesized speech segments 172 may be indicative of a corresponding one of the subset of the plurality of application elements 132. Each synthesized speech segment 172 may include one or more synthesized terms that describe the corresponding one of the application elements 132. More specifically, each of the plurality of synthesized speech segments 172 may describe a respective action 134 or content characterized by the corresponding one of the application elements 132 from the subset of the plurality of application elements 132. The screen reader 150 may audibly play (i.e., output) the plurality of speech segments 172 via the output audio device (e.g., speaker) 115. For example, if an application element 132 within the subset of application elements 132S is associated with a selectable button labeled “submit,” the synthesizer 170 will synthesize a corresponding speech segment 172 that verbally describes this button, such as “submit button.” Similarly, if an application element 132 within the subset of application elements 132S is associated with textual content, the synthesizer 170 will generate a corresponding speech segment 172 that reads aloud the textual content. Thus, by synthesizing the speech segments 172 and audibly outputting the synthesized speech segments 172 via the user device 110, the screen reader 150 audibly communicates the content from the application 130 that is associated with the targeted element class 162.

In some examples, the synthesizer 170 generates a plurality of haptic output segments 174 associated with the subset of the plurality of application elements 132S in addition to, or in lieu of, the speech segments 172. The haptic output segments 174 are configured to provide tactile feedback to the user 10, enhancing the accessibility and usability of the screen reader 150 for individuals with visual impairments. The haptic output segments 174 may convey different types of information through various patterns, intensities, and durations of vibrations or other tactile sensations. The screen reader 150 may cause the user device 110 to output the haptic output segments 174 via a tactile interface of the user device 110.

In some implementations, the plurality of application elements 132 of each application 130 includes a respective sequential order 136. When no indication 102 of user input 104 is received, the screen reader 150 is configured to generate synthesized speech segments 172 that describe a respective action 134 the respective application elements is configured to perform for each respective application element 132 and output the synthesized speech segments 172 based on the sequential order 136. For instance, the sequential order 136 may include a left-to-right and top-down order of the plurality of application elements 132 corresponding to the arrangement of the plurality of application elements 132 displayed on the screen 112 of the user device 110. As such, the sequential order 136 may correspond to an order that the user 10 would read or observe the plurality of application elements 132 displayed on the screen 112. Thus, when no user input 104 is received, the screen reader 150 may simply synthesize speech segments 172 that describe the respective actions 134 associated with all of the application elements 132 of the application and output the synthesized speech segments 172 in an order corresponding to the sequential order 136. Consequently, synthesized speech segments 172 for application elements 132 located at the bottom of the screen or otherwise at the end of the sequential order 136 may not be output until all other synthesized speech segments 172 earlier in the sequential order 136 are output. Simply outputting synthesized speech segments 172 according to the sequential order 136 may unnecessarily take more time and/or consume more computing resources when the user 10 knows the type of content they want the screen reader 150 to output.

To that end, the selector 200 may modify the sequential order 136 of the plurality of application elements 132 to move each identified application element 132 (e.g., application elements 132 in the subset of application elements 132S) earlier in the sequential order 136 than other application elements 132 not included in the subset of application elements 132S. Moreover, the selector 200 may modify the sequential order 136 by discarding application elements 132 not included in the subset of application elements 132S. As such, the synthesizer 170 may synthesize the plurality of speech segments 172 associated with the subset of the plurality of application elements 132S according to the modified sequential order 136, 136M such that the synthesized plurality of speech segments 172 are audibly output from the user device 110.

After synthesizing the plurality of speech segments 172, the screen reader may receive another indication 102 of another user input 104 selecting the respective action described by one of the speech segments 172 and cause the user device 110 to perform the respective action 134 based on receiving the other indication 102 of the other user input 104. For instance, if the other user input 104 selects a speech segment 172 that describes opening an email application, the screen reader 150 will send the appropriate command to the user device 110 to launch the email application. Similarly, if the selected speech segment 172 describes navigating to a specific section of a webpage, the screen reader 150 will instruct the user device 110 to scroll to or highlight that section.

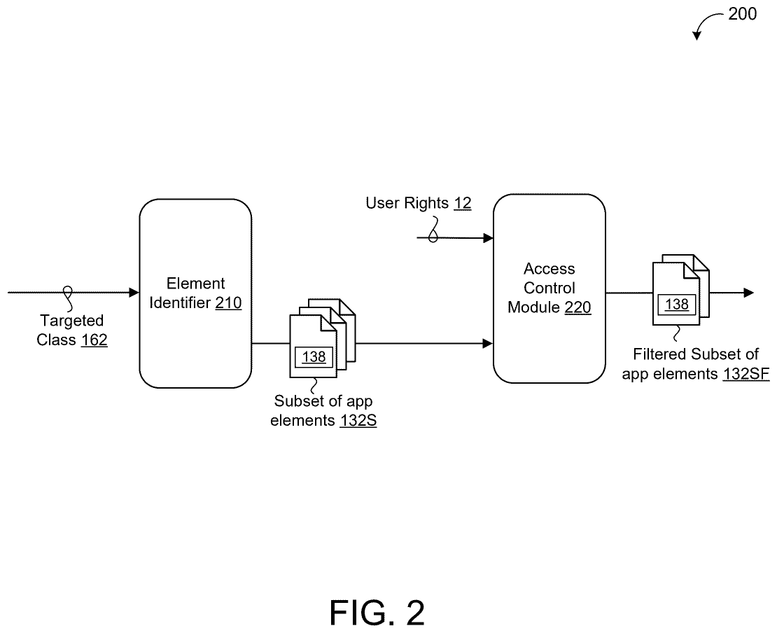

FIG. 2 illustrates an example selector 200 that includes an element identifier 210 and an access control module 220. In some examples, each respective application element 132 of the plurality of application elements 132 is associated with a respective access control level 138. The respective access control level 138 associated with each respective application element 132 denotes the level of access required to perform the respective action 134 associated with the respective application element 132. That is, each respective access control level 128 may define the level of user rights 12 required to access the respective application element 132. Thus, each user 10 may be associated with corresponding user rights 12 that define the rights and permissions of the user 10 to access application elements 132 within each application 130. For example, a user 10 that is an administrator may have full access to all application elements 132, including the ability to modify settings and configurations, while a user that is a regular user may have limited access to application elements 132. These regular users may be restricted to only access application elements 132 that are necessary for certain tasks. In short, user rights 12 ensures that users 10 may only access application elements 132 that the user 10 is authorized to access, thereby maintaining the integrity and security of the application while also providing a customized experience for each user 10.

To that end, the element identifier 210 may identify the subset of application elements 132S based on the targeted element class 162. Here, each application element 132 in the subset of application elements 132S is associated with a respective action 134 or content and is associated with a respective access control level 138. The access control module 220 receives or determines the user rights 12 of the user 10 associated with the user input 104 and receives each application element 132 in the subset of application elements 132S. For each respective application element 132 in the subset of application elements 132S, the access control module 220 determines whether the user rights 12 satisfy the respective access control level 138. That is, the access control module 220 generates a filtered subset of the plurality of application elements 132S, 132SF that includes respective application elements 132 in the subset of application elements 132S for which the user rights 12 satisfy the respective access control level 138 and discards respective application elements 132 in the subset of application elements 132S for which the user rights 12 fail to satisfy the respective access control level 138.

In some examples, the filtered subset of the plurality of application elements 132SF includes less application elements 132 than in the subset of the plurality of application elements 132S. In the example shown, the element identifier 210 identifies three application elements 132 for the subset of the plurality of application elements 132 and the access control module 220 generates the filtered subset of the application elements 132SF with two application elements 132. The selector 200 may output the filtered subset of the application elements 132SF in addition to, or in lieu of, the subset of the application elements 132S.

Referring back to FIG. 1, the synthesizer 170 may receive the filtered subset of the application elements 132SF (FIG. 2) and synthesize the plurality of speech segments 172 or haptic output segments 174 respectively associated with the filtered subset of the application elements 132SF. Here, the output of the synthesizer 170 may refrain from outputting any information that the user 10 that provided the user input 104 does not have sufficient access to interact with. The synthesizer 170 may include a vocoder or any text-to-speech (TTS) model. In some configurations, the synthesizer 170 is configurable such that the user 10 may configure the particular speaking prosody, pace, style, voice, and/or language of the synthesized speech segments 172. By modifying the prosody, users 10 can make the speech sound more natural and easier to understand, especially in different contexts or for different types of content. Here, prosody refers to the rhythm, stress, and intonation of the spoken words. Additionally, the pace of the speech can be configured, enabling users 10 to set the speed at which the synthesized speech segments 172 are read aloud. This is particularly useful for users 10 who may need the information quickly or for those who prefer a slower, more deliberate reading pace to better comprehend the content. The style of the speech can also be adjusted, allowing users 10 to choose from different speaking styles that may be more formal, casual, or even emotive, depending on their personal preferences or the nature of the text being read.

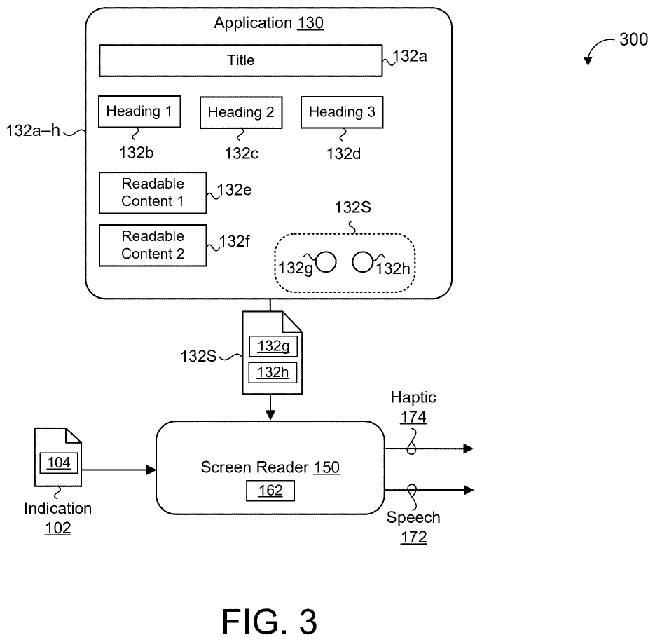

FIG. 3 illustrates a schematic view 300 of the screen reader 150 generating an output for an example indication 102 of a user input 104. In this example, the user input 104 may correspond to the keyboard shortcut of “Ctrl+Alt+1234” whereby the screen reader 150 determines the targeted element class 162 based on the indication 102 of the user input 104. Here, the targeted element class 162 is associated with an application 130 having a plurality of application elements 132, 132a-h. In this particular example, the keyboard shortcut of “Ctrl+Alt+1234” may be mapped to the targeted element class 162 of selectable button application elements 132. As such, the screen reader 150 identifies a subset of the plurality of application elements 132S based on the targeted element class. In the example shown, the application 130 includes a tile application element 132a, heading application elements 132b-d, readable content application elements 132e, f and selectable button application elements 132g, h.

Accordingly, the subset of the plurality of application elements 132S identified by the screen reader 150 in this example includes the selectable button application elements 132g, h. Thereafter, the screen reader 150 may synthesize speech segments 172 or haptic output segments 174 respectively associated with the selectable button application elements 132g, h. For instance, a first speech segment 172 may be respectively associated with a first selectable button application element 132g and a second speech segment 172 respectively associated with a second selectable button application element 132h. More specifically, the first speech segment 172 may correspond to “this is a backwards button” while the second speech segment 172 corresponds to “this is a forward button” thereby informing the user 10 of the respective action that would be performed if either application element 132 was selected.

Advantageously, because the screen reader 150 received the indication 102 of the user input 104, the screen reader 150 directly outputs the speech segments 172 or the haptic output segments 174 for the application elements 132g, h without generating any outputs the describe the other application elements 132a-f. In contrast, without receiving the indication of the user input 104, the screen reader 150 may generate outputs based on how the application elements 132 are arranged (e.g., left-to-right and top-to-bottom). Thus, by informing the screen reader 150 which application elements 132 the user 10 is interested in, the screen reader 150 may bypass generating outputs for application elements 132 the user 10 is not interested in thereby optimizing the consumption of computing resources.

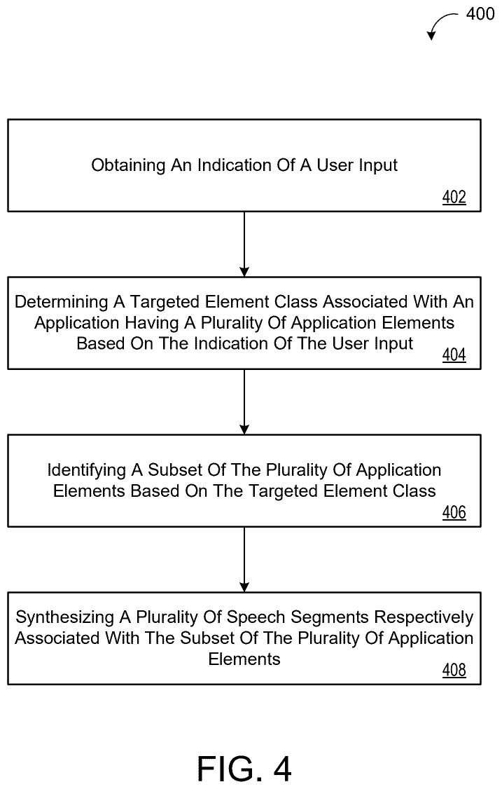

FIG. 4 is a flowchart of an exemplary arrangement of operations for a computer-implemented method 400 of using a screen reader 150 to provide standardized web navigation shortcuts. At operation 402, the method 400 includes obtaining an indication 102 of a user input 104. At operation 404, the method 400 includes determining a targeted element class 162 associated with an application 130 having a plurality of application elements 132 based on the indication 102 of the user input 104. At operation 406, the method 400 includes identifying a subset of the plurality of application elements 132S based on the targeted element class 162. Advantageously, by determining the targeted element class 162 and identifying the subset of the plurality of application elements 132S, the screen reader 150 focuses on the application elements 132 relevant to the user 10 as indicated by the user input 104. At operation 408, the method 400 includes synthesizing a plurality of speech segments 172 respectively associated with the subset of the plurality of application elements 132S. Notably, the synthesized plurality of speech segments 172 are associated with the subset of the plurality of application elements 132S rather than the plurality of application elements 132S. As such, the screen reader 150 may directly synthesize speech for application elements 132 of interest to the user 10 instead of synthesizing speech for each of the plurality of application elements 132, which reduces the computing resources consumed by the screen reader 150.

Accordingly, the indications 102, such as touch inputs, keyboard shortcuts, and/or voice commands, enable users 10 to direct the screen reader 150 to the targeted element class 162 mapped to the user input 104. Thus, instead of requiring the screen reader 150 to sequentially output all the content on the screen 112, which consumes a significant amount of time and computing resources, the user input 104 directs the screen reader 150 directly to the content associated with the targeted element class 162 the user 10 is interested in. Thus, the user input 104 enables the screen reader 150 to only output synthesized speech for the application elements 132 associated with the targeted element class 162 instead of sequentially processing all the application elements 132 displayed on the screen 112. Moreover, the screen reader 150 may filter out one of more application elements 132 included in the subset of application elements 132 based on the respective access control level 138 associated with each application element 132 and the user rights 12 of the user 10. By filtering the application elements 132, the screen reader 150 maintains privacy and security of the application and tailors personalized experiences for the user 10.

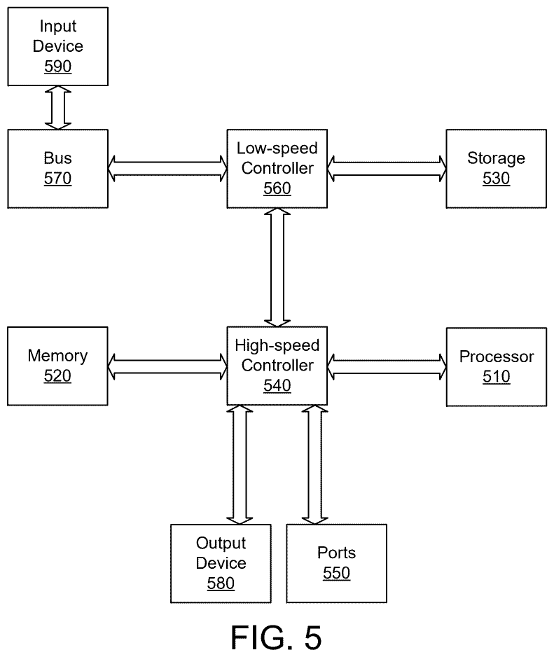

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining an indication of a user input;
determining, based on the indication of the user input, a targeted element class associated with an application having a plurality of application elements;
identifying a subset of the plurality of application elements based on the targeted element class; and
synthesizing a plurality of speech segments respectively associated with the subset of the plurality of application elements.

2. The method of claim 1, wherein each of the plurality of synthesized speech segments is indicative of a corresponding one of the subset of the plurality of application elements.

3. The method of claim 2, wherein each of the plurality of synthesized speech segments describes a respective action characterized by the corresponding one of the subset of the plurality of application elements.

4. The method of claim 1, wherein identifying the subset of the plurality of application elements includes determining that each of the subset of the plurality of application elements satisfies a relevance criterion with respect to the targeted element class.

5. The method of claim 1, further comprising playing the plurality of speech segments via an output audio device.

6. The method of claim 1, further comprising assigning the targeted element class to application elements of a plurality of different applications.

7. The method of claim 1, wherein:
the plurality of application elements of the application comprises a sequential order; and
a screen reader configured to:
for each respective application element, generate synthesized speech that describes a respective action the respective application element is configured to perform; and
output the synthesized speech based on the sequential order.

8. The method of claim 7, further comprising, based on identifying the subset of the plurality of application elements, modifying the sequential order of the plurality of application elements to move each identified application element earlier in the sequential order than other application elements.

9. The method of claim 7, wherein the sequential order comprises a left-to-right and a top-down order of the plurality of application elements.

10. The method of claim 1, wherein the indication of the user input comprises at least one of:
a keyboard shortcut;
a touch input; or
a voice command.

11. The method of claim 1, further comprising:
after synthesizing the plurality of speech segments, receiving another indication of another user input selecting a respective action described by one of the plurality of speech segments; and
performing the respective action based on receiving the other indication of the other user input.

12. The method of claim 1, wherein each respective application element of the plurality of application elements is associated with a respective access control level.

13. The method of claim 12, wherein the respective access control level is required to perform a respective action associated with the respective application element.

14. The method of claim 13, further comprising determining user rights of a user associated with the user input.

15. The method of claim 14, further comprising, for each respective application element in the subset of the plurality of application elements, determining that the user rights satisfy the respective access control level.

16. The method of claim 1, wherein the application comprises a web-based application or a mobile application.

17. The method of claim 1, wherein determining the targeted element class comprises determining, from a plurality of different targeted element classes, that the targeted element class is mapped to the indication of the user input.

18. The method of claim 1, further comprising executing the application, each application element of the plurality of application elements configured to perform a respective action associated with the application and assigned to a respective targeted element class of a plurality of targeted element classes.

19. A system comprising:
data processing hardware; and
memory hardware in communication with the data processing hardware, the memory hardware storing instructions that when executed on the data processing hardware cause the data processing hardware to perform operations comprising:
obtaining an indication of a user input;
determining, based on the indication of the user input, a targeted element class associated with an application having a plurality of application elements;
identifying a subset of the plurality of application elements based on the targeted element class; and
synthesizing a plurality of speech segments respectively associated with the subset of the plurality of application elements.

20. A computer-readable medium having instructions that, when executed by data processing hardware, causes the data processing hardware to perform operations comprising:
obtaining an indication of a user input;
determining, based on the indication of the user input, a targeted element class associated with an application having a plurality of application elements;
identifying a subset of the plurality of application elements based on the targeted element class; and
synthesizing a plurality of speech segments respectively associated with the subset of the plurality of application elements.
